(19) United States
(12) Patent Application Publication
(10) Pub. No.: US 2015/0193191 A1
(43) Pub. Date: Jul. 9, 2015

(54) AUDIO DATA SYNTHESIZING APPARATUS

(71) Applicant: NIKON CORPORATION, Tokyo (JP)

(72) Inventor: Hidefumi OTA, Kawasaki-shi (JP)

(21) Appl. No.: 14/665,445

(22) Filed: Mar. 23, 2015

Related U.S. Application Data
(63) Continuation of application No. 13/391,951, filed on Feb. 23, 2012, now abandoned.

(30) Foreign Application Priority Data
Sep. 4, 2009 (JP) 2009-204601

(51) Int. Cl. G06F 3/16; G10L 25/48

(52) U.S. Cl. CPC G06F 3/16; G10L 25/48

(57) ABSTRACT

An audio data synthesizing apparatus includes an imaging unit that captures an image of a subject through the use of an optical system and outputs image data, an audio data acquiring unit that acquires audio data, an audio data separating unit that separates first audio data produced by the subject and second audio data other than the first audio data from the audio data, and an audio data synthesizing unit that synthesizes the first audio data and the second audio data of which gains and phases are controlled for each channel of the audio data to be output to a multi-speaker on the basis of the gain and a phase adjustment amount set for each channel.

### CROSS-REFERENCE TO RELATED APPLICATIONS

This is a Continuation of application Ser. No. 13/391,951 filed Feb. 23, 2012, which in turn is a National Stage of International Application No. PCT/JP2010/065146 filed Sep. 3, 2010, which claims the benefit of Japanese Application No. 2009-204601 filed Sep. 4, 2009. The disclosure of the prior applications is hereby incorporated by reference herein in its entirety.

### TECHNICAL FIELD

The present invention relates to an audio data synthesizing apparatus including an imaging unit that captures an optical image through the use of an optical system.

Priority is claimed on Japanese Patent Application No. 2009-204601, filed on Sep. 4, 2009, the contents of which are incorporated herein by reference.

### BACKGROUND ART

Recently, an imaging apparatus having a single microphone for recording a sound has been known (for example, see Patent Document 1, shown below).

### PRIOR ART DOCUMENTS

### Patent Document

[Patent Document 1] Japanese Unexamined Patent Application, First Publication No. 2005-215079

### SUMMARY OF INVENTION

### Problems to be Solved by the Invention

However, it is more difficult to detect the position or direction where a sound was produced, by a monophonic audio data acquired through the use of a single microphone than by a stereophonic audio data acquired through the use of two microphones. Accordingly, when the audio data is reproduced by the use of a multi-speaker, there is a problem in that a satisfactory acoustic effect cannot be achieved.

An object of aspects of the invention is to provide an audio data synthesizing apparatus which can generate an audio data which is capable of improving the acoustic effect, when the audio data acquired by a microphone is reproduced by a multi-speaker in a small-scale apparatus having the microphone built therein.

### Means for Solving the Problems

According to an aspect of the invention, there is provided an audio data synthesizing apparatus including: an imaging unit that captures an image of a subject through an use of an optical system and outputs image data; an audio data acquiring unit that acquires audio data; an audio data separating unit that separates first audio data produced by the subject and second audio data other than the first audio data from the audio data; and an audio data synthesizing unit that synthesizes the first audio data and the second audio data of which gains and phases are controlled for each channel of the audio data to be output to a multi-speaker on the basis of a gain and a phase adjustment amount set for each channel.

### Advantage of the Invention

In the audio data synthesizing apparatus according to the aspects of the invention, it is possible to generate an audio data which is capable of improving an acoustic effect when the audio data acquired by a microphone is reproduced by a multi-speaker in a small-scale apparatus having the microphone built therein.

### BRIEF DESCRIPTION OF THE DRAWINGS

FIG. 1 is a perspective view schematically illustrating an example of an imaging apparatus including an audio data synthesizing apparatus according to an embodiment of the invention.

FIG. 2 is a block diagram illustrating an example of the configuration of the imaging apparatus shown in FIG. 1.

FIG. 3 is a block diagram illustrating an example of the configuration of the audio data synthesizing apparatus according to the embodiment of the invention.

FIG. 4 is a diagram schematically illustrating a sound production period detected by a sound production period detecting unit included in the audio data synthesizing apparatus according to the embodiment of the invention.

FIG. 5A is a diagram schematically illustrating frequency bands acquired through the processing of an audio data separating unit included in the audio data synthesizing apparatus according to the embodiment of the invention.

FIG. 5B is a diagram schematically illustrating frequency bands acquired through the processing of the audio data separating unit included in the audio data synthesizing apparatus according to the embodiment of the invention.

FIG. 5C is a diagram schematically illustrating frequency bands acquired through the processing of the audio data separating unit included in the audio data synthesizing apparatus according to the embodiment of the invention.

FIG. 6 is a conceptual diagram illustrating an example of the process of the audio data synthesizing unit included in the audio data synthesizing apparatus according to the embodiment of the invention.

FIG. 7 is a diagram schematically illustrating the positional relationship between a subject and an optical image when the optical image of the subject is formed on an image pickup device through an optical system included in the audio data synthesizing apparatus according to the embodiment of the invention.

FIG. 8 is a reference diagram illustrating a moving image captured by the imaging apparatus according to the embodiment of the invention.

FIG. 9 is a flowchart illustrating an example of the sound production period detecting method using the sound production period detecting unit included in the audio data synthesizing apparatus according to the embodiment of the invention.

FIG. 10 is a flowchart illustrating an example of the audio data separating and synthesizing method using the audio data separating unit and the audio data synthesizing unit included in the audio data synthesizing apparatus according to the embodiment of the invention.

FIG. 11 is a reference diagram illustrating a gain and a phase adjustment amount acquired in the example shown in FIG. 8.

### DESCRIPTION OF EMBODIMENTS

Hereinafter, an imaging apparatus according to an embodiment of the invention will be described with reference to the accompanying drawings.

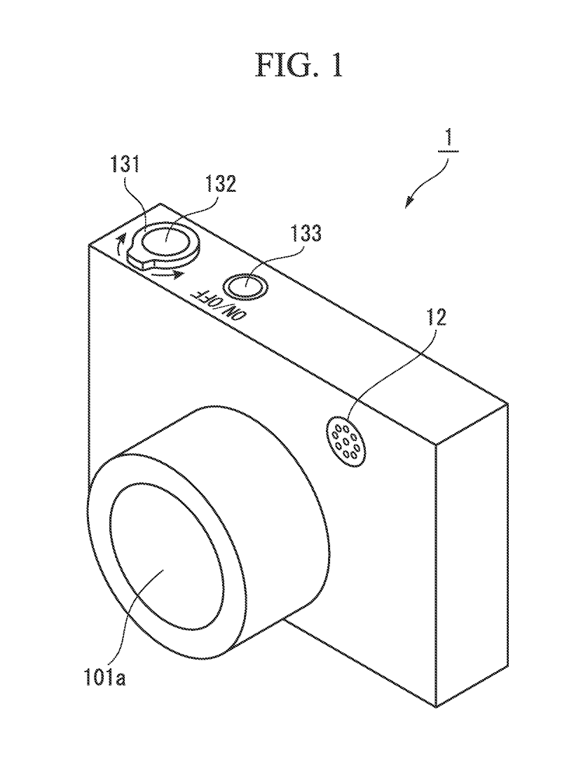

FIG. 1 is a perspective view schematically illustrating an example of an imaging apparatus 1 including an audio data synthesizing apparatus according to an embodiment of the invention. The imaging apparatus 1 is an imaging apparatus capable of capturing a moving image and an apparatus capable of continuously capturing plural image data as plural frames.

As shown in FIG. 1, the imaging apparatus 1 includes a shooting lens 101a, an audio data acquiring unit 12, and an operation unit 13. The operation unit 13 includes a zoom button 131, a release button 132, and a power button 133 which are used to receive an operation input from a user.

The zoom button 131 receives an input of adjustment amount for shifting the shooting lens 101a to adjust the focal distance from a user. The release button 132 receives an input for instructing to start the shooting of an optical image input via the shooting lens 101a and an input for instructing to end the shooting. The power button 133 receives a turn-on input for turning on the imaging apparatus 1 and a turn-off input for turning off the power of the imaging apparatus 1.

The audio data acquiring unit 12 is disposed on the front surface (that is, the surface on which the shooting lens 101a is mounted) of the imaging apparatus 1 and acquires audio data of a sound produced during the shooting. In the imaging apparatus 1, directions are defined in advance. That is, the positive (+) X axis direction is defined as left, the negative (−) X axis direction is defined as right, the positive (+) Z axis direction is defined as front, and the negative (−) Z axis direction is defined as rear.

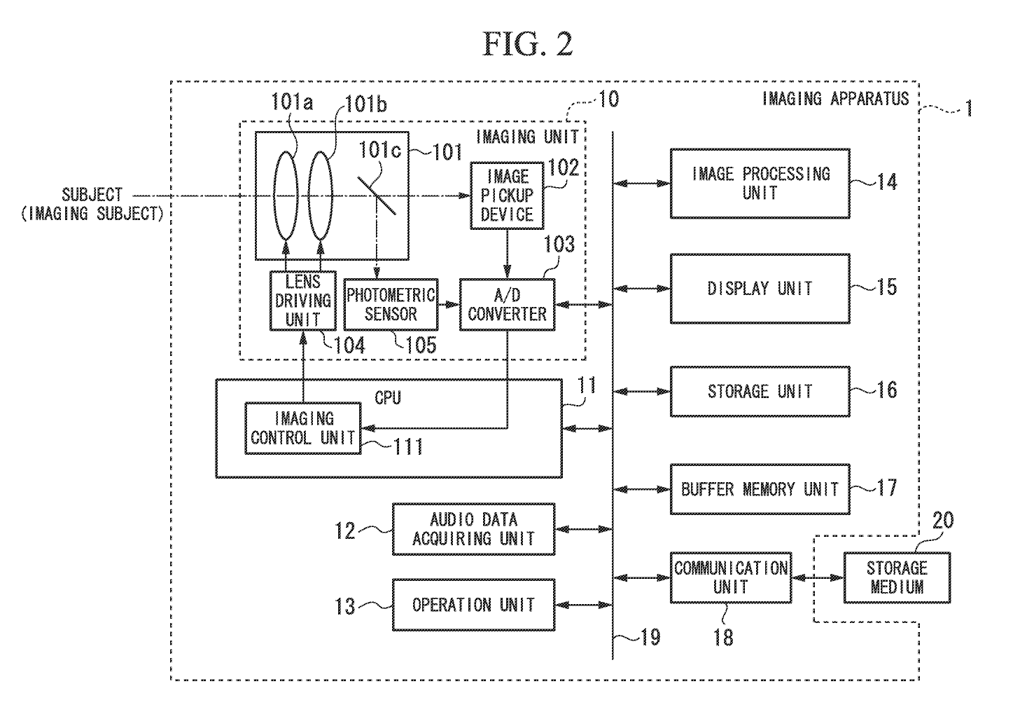

The configuration of the imaging apparatus 1 will be described below with reference to FIG. 2. FIG. 2 is a block diagram illustrating the configuration of the imaging apparatus 1.

As shown in FIG. 2, the imaging apparatus 1 according to this embodiment includes an imaging unit 10, a CPU (Central Processing Unit) 11, an audio data acquiring unit 12, an operation unit 13, an image processing unit 14, a display unit 15, a storage unit 16, a buffer memory unit 17, a communication unit 18, and a bus 19.

The imaging unit 10 includes an optical system 101, an image pickup device 102, an A/D (Analog/Digital) converter 103, a lens driving unit 104, and a photometric sensor 105, is controlled by the CPU 11 depending on the set imaging conditions (such as an aperture value and an exposure value), and forms an optical image on the image pickup device 102 through the use of the optical system 101 to generate image data based on the optical image which is converted into digital signals by the A/D converter 103.

The optical system 101 includes a zoom lens 101a, a focus adjusting lens (hereinafter, referred to as an AF (Auto Focus) lens) 101b, and a spectroscopic member 101c. The optical system 101 guides the optical image passing through the zoom lens 101a, the AF lens 101b, and the spectroscopic member 101c to the imaging plane of the image pickup device 102. The optical system 101 guides the optical images separated by the spectroscopic member 101c between the AF lens 101b and the image pickup device 102 to the light-receiving plane of the photometric sensor 105.

The image pickup device 102 converts the optical image formed on the imaging plane into electrical signals and outputs the electrical signals to the A/D converter 103.

The image pickup device 102 stores the image data, which is acquired when a shooting instruction is input via the release button 132 of the operation unit 13, as image data of a captured moving image in a storage medium 20 and outputs the image data to the CPU 11 and the display unit 14.

The A/D converter 103 digitalizes the electrical signals converted by the image pickup device 102 and outputs image data which are digital signals.

The lens driving unit 104 includes detection measures for detecting a zoom position representing the position of the zoom lens 101a and a focus position representing the position of the AF lens 101b, and includes driving measures for driving the zoom lens 101a and the AF lens 101b. The lens driving unit 104 outputs the zoom position and the focus position detected by the detection measures to the CPU 11. When a driving control signal is generated by the CPU 11 on the basis of the information, the driving measures of the lens driving unit 104 controls the positions of both lenses on the basis of the driving control signal.

The photometric sensor 105 forms the optical image separated by the spectroscopic member 101c on the light-receiving plane, acquires a brightness signal representing the brightness distribution of the optical image, and outputs the brightness signal to the A/D converter 103.

The CPU 11 is a main controller comprehensively controlling the imaging apparatus 1 and includes an imaging control unit 111.

The imaging control unit 111 receives the zoom position and the focus position detected by the detection measures of the lens driving unit 104 and generates a driving control signal on the basis of the received information.

For example, when the face of a subject is recognized by an sound production period detecting unit 210 to be described later, the imaging control unit 111 calculates the focal distance f from the focus to the imaging plane of the image pickup device 102 on the basis of the focus position acquired by the lens driving unit 104 while shifting the AF lens 101b so as to focus on the face of the subject. The imaging control unit 111 outputs the calculated focal distance f to a displacement angle detecting unit 260 to be described later.

The CPU 11 provides synchronization information representing the elapsed time counted after the imaging is started in the same time axis to image data continuously acquired by the imaging unit 10 and audio data acquired by the audio data acquiring unit 12. Accordingly, the audio data acquired by the audio data acquiring unit 12 is synchronized with the image data acquired by the imaging unit 10.

The audio data acquiring unit 12 is, for example, a microphone acquiring sounds around the imaging apparatus 1 and outputs the audio data of the acquired sounds to the CPU 11.

The operation unit 13 includes a zoom button 131, a release button 132, and a power button 133 as described above, receives a user's operation input based on the user's operation, and outputs a signal to the CPU 11.

The image processing unit 14 performs an imaging process on the image data recorded in the storage medium 20 with reference to image processing conditions stored in the storage unit 16.

The display unit 15 is, for example, a liquid crystal display and displays image data acquired by the imaging unit 10, an operation picture, and the like.

The storage unit 16 stores information referred to when the gain or the phase adjustment amount is calculated by the CPU 11, or information such as imaging conditions.

The buffer memory unit 17 temporarily stores image data captured by the imaging unit 10 or the like.

The communication unit 18 is connected to a removable storage medium 20 such as a card memory and performs writing, reading, and deleting of information on the storage medium 20.

The bus 19 is connected to the imaging unit 10, the CPU 11, the audio data acquiring unit 12, the operation unit 13, the image processing unit 14, the display unit 15, the storage unit 16, the buffer memory unit 17, and the communication unit 18 and transmits data output from the units and the like.

The storage medium 20 is a storage unit detachably attached to the imaging apparatus 1 and stores, for example, image data acquired by the imaging unit 10 and audio data acquired by the audio data acquiring unit 12.

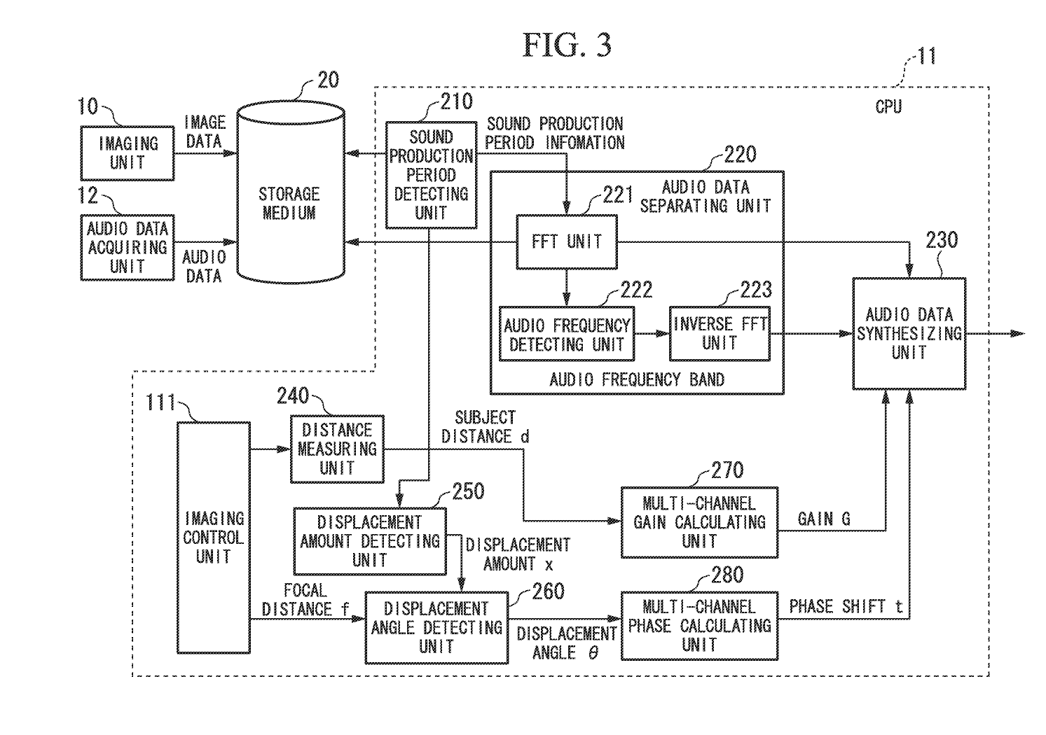

The audio data synthesizing apparatus according to this embodiment will be described below with reference to FIG. 3. FIG. 3 is a block diagram illustrating the configuration of the audio data synthesizing apparatus according to this embodiment.

As shown in FIG. 3, the audio data synthesizing apparatus includes an imaging unit 10, an audio data acquiring unit 12, an imaging control unit 111 included in a CPU 11, an sound production period detecting unit 210, an audio data separating unit 220, an audio data synthesizing unit 230, a distance measuring unit 240, a displacement amount detecting unit 250, a displacement angle detecting unit 260, a multi-channel gain calculating unit 270, and a multi-channel phase calculating unit 280.

The sound production period detecting unit 210 detects the sound production period in which a sound is produced from a subject on the basis of the image data captured by the imaging unit 10, and outputs sound production period information representing the sound production period to the audio data separating unit 220.

In this embodiment, the subject of imaging is a person and the sound production period detecting unit 210 performs a face recognizing process on the image data to recognize the face of the person as a subject, additionally detects image data of the area of the mouth in the face, and detects the period in which the shape of the mouth is changing as the sound production period.

Specifically, the sound production period detecting unit 210 has a face recognizing function and detects an image region where the face of the person is imaged, out of the image data acquired by the imaging unit 10. For example, the sound production period detecting unit 210 performs a feature extracting process on the image data acquired in real time by the imaging unit 10, and extracts feature amount, such as the shape of the face, the shape or arrangement of the eyes or nose, and the color of the skin, which constitutes the face. The sound production period detecting unit 210 compares the extracted feature amount with the image data (for example, information representing the shape of the face, the shape or arrangement of the eyes or nose, the color of the skin, and the like) of a predetermined template representing a face, detects the image region of the face of the person within the image data, and detects the image region in which the mouth is located in the face.

When the sound production period detecting unit 210 detects the image region of the face of the person within the image data, the sound production period detecting unit 210 generates pattern data representing the face based on the image data corresponding to the face, and tracks the face of the imaging subject which is moving in the image data on the basis of the generated pattern data of the face.

The sound production period detecting unit 210 compares the image data of the image region in which the position of the mouth which is detected with the image data of a predetermined template representing an opened or closed state of a mouth, and detects the opened or closed state of the mount of the imaging subject.

More specifically, the sound production period detecting unit 210 includes a storage unit inside which storing a mouth-opened template representing a state where the mouth of the person is opened, a mouth-closed template representing a state where the mouth of the person is closed, and determination criteria for determining whether the mouth of the person is opened or closed on the basis of the results of the comparison of image data with the mouth-opened template and the mouth-closed template. The sound production period detecting unit 210 compares the mouth-opened template with the image data of the image region in which the mouth is located with reference to the storage unit, and determines whether the mouth is in the opened state on the basis of the comparison result. When the mouth is in the opened state, it is determined that the image data including the image region in which the mouth is located is in the opened state. Similarly, the sound production period detecting unit 210 determines whether the mouth is in the closed state, and when the mouth is in the closed state, it determines that the image data including the image region in which the mouth is located is in the closed state.

The sound production period detecting unit 210 detects a variation amount of the opened or closed state of the image data which was acquired in this way, and detects a predetermined period as the sound production period, for example, when the opened or closed state varies continuously equal to or more than the predetermined period.

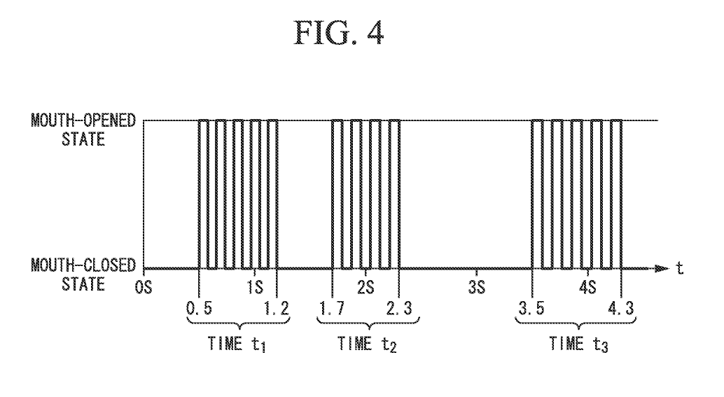

This will be described below in more detail with reference to FIG. 4. FIG. 4 is a diagram schematically illustrating the sound production period detected by the sound production period detecting unit 210.

As shown in FIG. 4, when plural image data corresponding to the each frames are acquired by the imaging unit 10, the image data are compared with the mouth-opened template and the mouth-closed template by the sound production period detecting unit 210 as described above, and it is determined whether the image data is in the mouth-opened state or in the mouth-closed state. This determination result is shown in FIG. 4. The imaging start point is defined as 0 second and the image data is changed between the mouth-opened state and the mouth-closed state during a t1 section which is between 0.5 and 1.2 second, a t2 section which is between 1.7 and 2.3 second, and a t3 section which is between 3.5 and 4.3 second.

The sound production period detecting unit 210 detects the t1, t2, and t3 sections in which the opened or closed state is continuously changed for a predetermined time as the sound production periods.

The audio data separating unit 220 separates the audio data acquired by the audio data acquiring unit 12 into subject audio data produced from the imaging subject and peripheral audio data produced from something other than the subject.

Specifically, the audio data separating unit 220 includes an FFT unit 221, an audio frequency detecting unit 222, and an inverse FFT unit 223, separates subject audio data, which is produced from a person who is an imaging subject, from the audio data, which is acquired from the audio data acquiring unit 12, on the basis of sound production period information detected by the sound production period detecting unit 210, and sets the remainder audio data other than the subject audio data in the audio data as peripheral audio data.

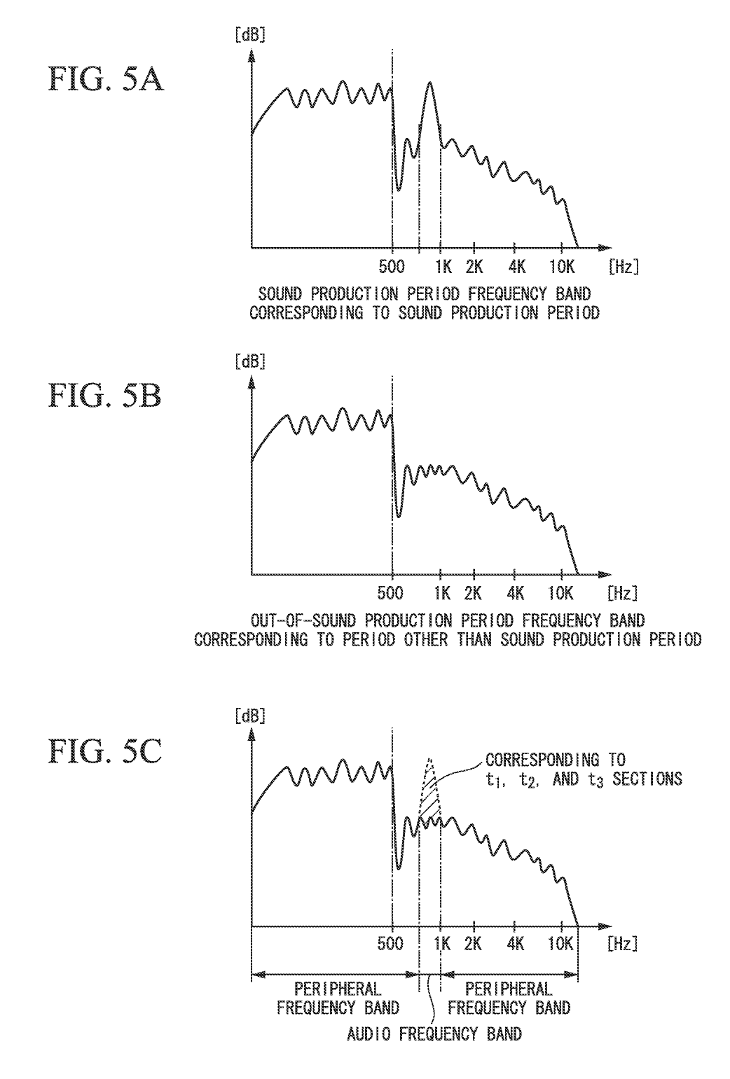

The elements of the audio data acquiring unit 12 will be described below in detail with reference to FIGS. 5A to 5C. FIGS. 5A to 5C are diagrams schematically illustrating frequency bands acquired through the processes of the audio data separating unit 220.

The FFT unit 221 separates the audio data, which is acquired by the audio data acquiring unit 12, into audio data, which corresponds to the sound production period, and audio data, which corresponds to the other than the sound production period, on the basis of the sound production period information input from the sound production period detecting unit 210, and performs a Fourier transform to the audio data, respectively. Accordingly, it is possible to acquire an sound production period frequency band of the audio data corresponding to the sound production period as shown in FIG. 5A and an out-of-sound production period frequency band of the audio data corresponding to the period other than the sound production period as shown in FIG. 5B.

The sound production period frequency band and the out-of-sound production period frequency band are preferably based on the audio data of a time region which is neighbor of the time acquired by the audio data acquiring unit 12. Here, the audio data of the out-of-sound production period frequency band is generated from the audio data which is in the period of other than the sound production period and which is just before or after the sound production period.

The FFT unit 221 outputs the sound production period frequency band of the audio data corresponding to the sound production period and the out-of-sound production period frequency band of the audio data corresponding to the period other than the sound production period to the audio frequency detecting unit 222, and outputs the audio data, which is separated from the audio data acquired by the audio data acquiring unit 12 on the basis of the sound production period information, and which corresponds to the period of the sound production period, to the audio data synthesizing unit 230.

The audio frequency detecting unit 222 compares the sound production period frequency band of the audio data corresponding to the sound production period with the out-of-sound production period frequency band of the audio data corresponding to the other period on the basis of the result of the Fourier transform of the audio data acquired by the FFT unit 221, and detects an audio frequency band which is a frequency band of the imaging subject during the sound production period.

That is, the difference shown in FIG. 5C is detected by comparing the sound production period frequency band shown in FIG. 5A with the out-of-sound production period frequency band shown in FIG. 5B and taking a difference of the sound production period frequency band and the out-of-sound production period frequency band. This difference is a value appearing only in the sound production period frequency band. When the audio frequency detecting unit 222 takes the difference of the sound production period frequency band and the out-of-sound production period frequency band, the audio frequency detecting unit 222 discards a minute value of difference which is less than a predetermined value and detects a value equal to or more than the predetermined value as the difference.

Therefore, it can be considered that the difference is a frequency band generated during the sound production period in which the opened or closed state of the mouth of the imaging subject is changing, and can be considered that it is a frequency band of a sound which was produced by the imaging subject.

The audio frequency detecting unit 222 detects the frequency band, which corresponds to the difference, as an audio frequency band of the imaging subject in the sound production period. Here, as shown in FIG. 5C, 932 to 997 Hz is detected as the audio frequency band and the other frequency band is detected as the peripheral frequency band.

Here, since the imaging subject is a person, the audio frequency detecting unit 222 compares the sound production period frequency band corresponding to the audio data in the sound production period with the out-of-sound production period frequency band corresponding to the audio data in the period other than the sound production period, in a frequency range which is an orientable region (equal to or more than 500 Hz) in which a human being can recognize the direction of a sound. Accordingly, even when a sound that is less than 500 Hz is included during only the sound production period, it is possible to prevent the audio data of the frequency band that is less than 500 Hz from being erroneously detected as a sound produced by the imaging subject.

The inverse FFT unit 223 extracts the audio frequency band, which is acquired by the audio frequency detecting unit 222, from the sound production period frequency band during the sound production period acquired by the FFT unit 221, performs an inverse Fourier transform on the extracted audio frequency band, and detects the subject audio data. The inverse FFT unit 223 performs the inverse Fourier transform on the peripheral frequency band which is the remainder obtained by removing the audio frequency band from the sound production period frequency band, and detects the peripheral audio data.

Specifically, the inverse FFT unit 223 generates a band-pass filter, which passes the audio frequency band, and a band-elimination filter, which passes the peripheral frequency band. The inverse FFT unit 223 extracts the audio frequency band from the sound production period frequency band by the use of the band-pass filter, extracts the peripheral frequency band from the out-of-sound production period frequency band by the use of the band-elimination filter, and performs the inverse Fourier transform on the extracted frequency bands, respectively. The inverse FFT unit 223 outputs the peripheral audio data and the subject audio data acquired from the audio data in the sound production period to the audio data synthesizing unit 230.

The audio data synthesizing unit 230 controls a gain and a phase of the subject audio data on the basis of a gain and a phase adjustment amount which are set for each channel of the audio data that outputs to the multi-speaker, and synthesizes the subject audio data and the peripheral audio data, for each channel.

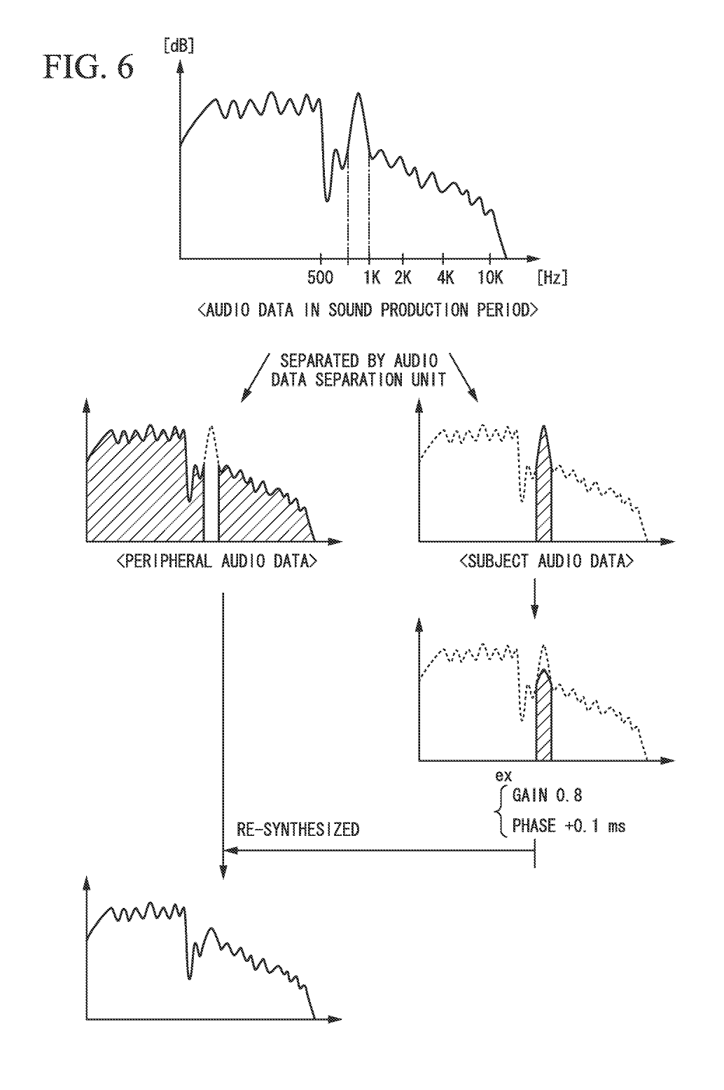

Here, a detail explanation will be made with reference to FIG. 6. FIG. 6 is a conceptual diagram illustrating an exemplary process in the audio data synthesizing unit 230.

As shown in FIG. 6, the peripheral audio data and the subject audio data separated from the audio data during the sound production period frequency band by the audio data separating unit 220 are input to the audio data synthesizing unit 230. The audio data synthesizing unit 230 controls the gain and the phase adjustment amount, which will be described in detail later, for only the subject audio data, synthesizes the controlled subject audio data with the non-controlled peripheral audio data, and reproduce the audio data corresponding to the sound production period.

The audio data synthesizing unit 230 synthesizes the audio data, corresponding to the sound production period which was reproduced as described above, with the audio data, which is input from the FFT unit 223 and corresponds to the period other than the sound production period, in the chronological order on the basis of synchronization information.

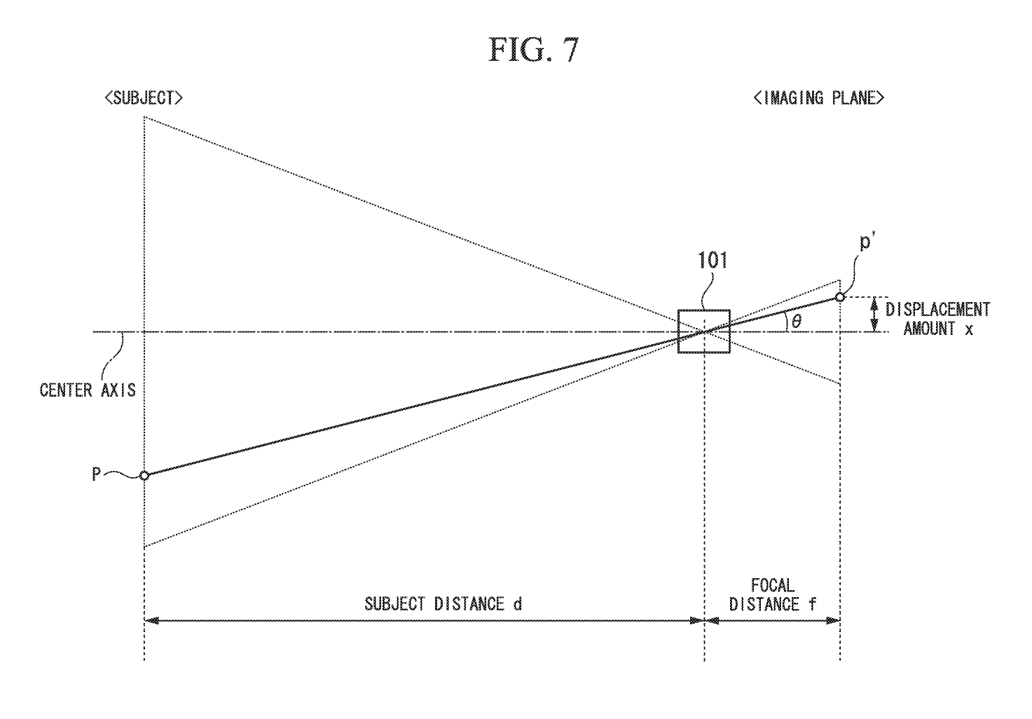

An example of the method of calculating the gain and the phase will be described below with reference to FIG. 7. FIG. 7 is a diagram schematically illustrating the positional relationship between a subject and an optical image when the optical image of the subject is formed on the image pickup device 102 through the use of the optical system 101.

As shown in FIG. 7, a distance from the subject to a focus of the optical system 101 is defined as a subject distance d and a distance from the focus to the optical image formed on the image pickup device 102 is defined as a focal distance f. When a person P as an imaging subject is located at a position apart from the focus of the optical system 101, the optical image formed on the image pickup device 102 is formed at a position deviated by a displacement amount x from the position crossing an axis (hereinafter, referred to as a center axis) which passes through the focus and which is perpendicular to the imaging plane of the image pickup device 102. In this way, an angle formed by a line connecting the focus to the optical image P′ of the person P formed at the position deviated by the displacement amount x from the center axis and the center axis is defined as a displacement angle θ.

The distance measuring unit 240 calculates the subject distance d from the subject to the focus of the optical system 101 on the basis of the zoom position and the focus position input from the imaging control unit 111.

Here, as described above, the lens driving unit 104 causes the focus lens 101b to move in the optical axis direction to bring into focus on the basis of the driving control signal generated by the imaging control unit 111, and the distance measuring unit 240 calculates the subject distance d on the basis of the relationship that the product of the “shift of the focus lens 101b” and the “image surface shift factor (γ) of the focus lens 101b” is a “variation in image position Δb from co to the position of the subject”.

The displacement amount detecting unit 250 detects the displacement amount x representing a length by which the face of the imaging subject is separated in the lateral direction of the subject from the center axis which passes through the center of the image pickup device 102 on the basis of the position information of the face of the imaging subject detected by the sound production period detecting unit 210.

The lateral direction of the subject agrees to the lateral direction in the image data acquired by the image pickup device 102, when the upward, downward, right, and left directions determined in the imaging apparatus 1 are the same as the upward, downward, right, and left directions of the imaging subject. On the other hand, when the imaging apparatus 1 rotates and thus the upward, downward, right, and left directions determined in the imaging apparatus 1 are not the same as the upward, downward, right, and left directions of the imaging subject, the right and left directions of a subject may be calculated, for example, on the basis of the displacement of the imaging apparatus 1 obtained by an angular velocity detector included in the imaging apparatus 1 or the right and left directions of the subject in the acquired image data may be calculated.

The displacement angle detecting unit 260 detects the displacement angle θ formed by, a line connecting the focus and the optical image P′ of the person P, which is the subject on the imaging plane of the image pickup device 102, and the center axis, based on the displacement amount x acquired from the displacement amount detecting unit 250 and the focal distance f acquired from the imaging control unit 111.

The displacement angle detecting unit 260 detects the displacement angle θ, for example, using a computing equation expressed by the following expression.

[Number 1]

X=f·tan θ (Expression 1)

The multi-channel gain calculating unit 270 calculates a gain (amplification factor) of audio data for each channel of the multi-speaker on the basis of the subject distance d calculated by the distance measuring unit 240.

The multi-channel gain calculating unit 270 gives the gain expressed by the following expression to the audio data output to the speakers disposed, for example, in the front of or in the back of a user depending on the channels of the multi-speaker.

[Number 2]

Gf=k₁·log_{K}_{₂}(d) (Expression 2)

[Number 3]

Gr=k₃·log_{K4}(1/d) (Expression 3)

Gf represents a gain to be given to the audio data of a front channel output to the speaker disposed in the front of the user and Gr represents a gain to be given to the audio data of a rear channel output to the speaker disposed in the back of the user. k₁ and k₃ represent effect coefficients which can emphasize a specific frequency and k₂ and k₄ represent effect coefficients which can change a sense of distance of a sound source of a specific frequency. For example, the multi-channel gain calculating unit 270 can calculate Gf and Gr with a specific frequency emphasized, as for the specific frequency, by calculating Gf and Gr which are expressed by Expressions 2 and 3 using the effect coefficients k₁ and k₃ and, as for a frequency other than the specific frequency, by calculating Gf and Gr which are expressed by Expressions 2 and 3 using different effect coefficients other than the effect coefficients k₁ and k₃.

These measures are to perform pseudo-localization of sound image using a sound pressure level difference and to perform localization of the sense of distance in the front direction.

In this way, the multi-channel gain calculating unit 270 calculates the gains of the front and rear channels (the front channel and the rear channel) by the sound pressure level differences between the front and rear channels of the imaging apparatus 1 including the audio data synthesizing apparatus on the basis of the subject distance d.

The multi-channel phase calculating unit 280 calculates a phase adjustment amount Δt to be given to the audio data for each channel of the multi-speaker in the sound production period on the basis of the displacement angle θ detected by the displacement angle detecting unit 260.

The multi-channel phase calculating unit 280 gives a phase adjustment amount Δt, which is expressed by the following expressions, to the audio data output to the speakers disposed, for example, on the right and left sides of the user depending on the channels of the multi-speaker.

[Number 4]

Δt_{R}=0.65·(90/θ)/2 [ms] (Expression 4)

[Number 5]

Δt_{L}=−0.65·(90/θ)/2 [ms] (Expression 5)

Δt_{R} represents a phase adjustment amount to be given to the audio data of the right channel output to the speaker disposed on the right side of the user and Δt_{L} represents a phase adjustment amount to be given to the audio data of the left channel output to the speaker disposed on the left side of the user. The phase difference between the right and left sides can be calculated by the use of Expressions 4 and 5, and the time differences t_{R} and t_{L} (phase) between the right and left sides related to the phase difference can be obtained.

This is to perform pseudo-localization of sound image through the control of the time difference and to use the localization of sound image on the right and left sides.

Specifically, a human being can recognize one of the right or left direction which a sound is heard, because the arrival times when the sound reaches the right and left ears are different depending on the incident angle of the sound (Haas effect). In the relationship between the incident angle of sound and the time difference of both ears, a sound (with an incident angle of 0 degree) incident from the front of the user and a sound (with an incident angle of 95 degree) incident from the lateral of the user have a difference in arrival time of about 0.65 ms. Here, the sound velocity is V=340 m/sec.

Expressions 4 and 5 are relational expressions between the displacement angle θ which is the incident angle of sound and the time difference by which a sound is incident on both ears, and the multi-channel phase calculating unit 280 calculates the phase adjustment amount Δt_{R} and Δt_{L} to be controlled for each of the right and left channels by using Expressions 4 and 5.

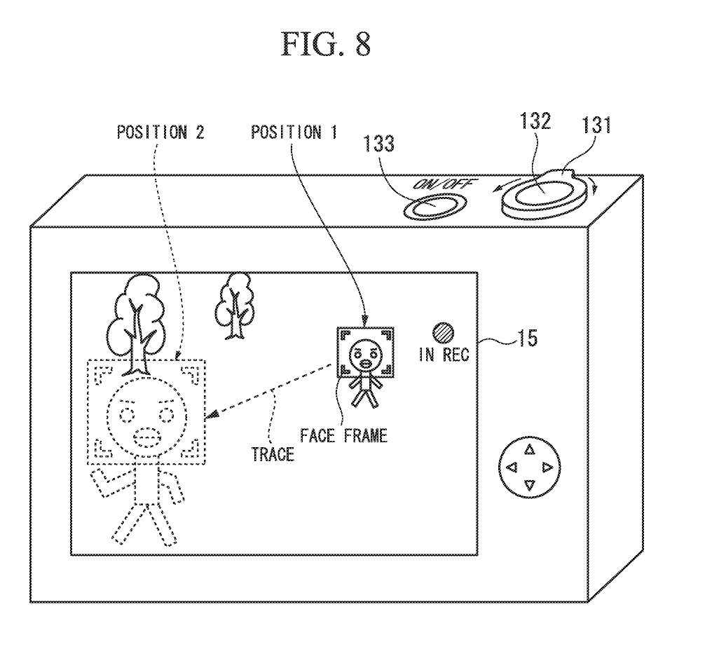

An example of the audio data synthesizing method in the imaging apparatus 1 including the audio data synthesizing apparatus according to this embodiment will be described below with reference to FIGS. 8 to 11.

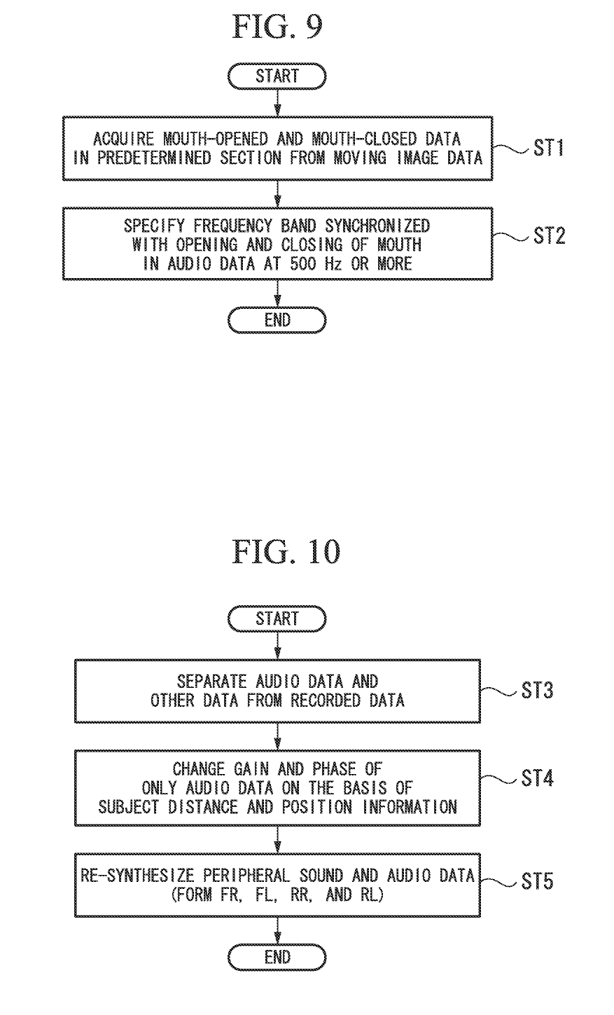

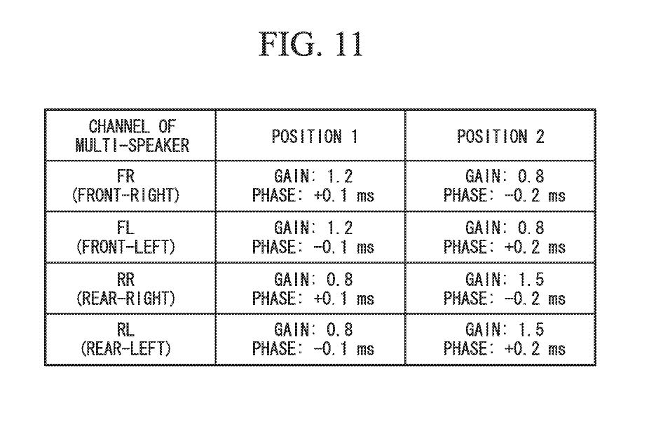

FIG. 8 is a reference diagram illustrating a moving image captured by the imaging apparatus 1. FIG. 9 is a flowchart illustrating an example of the method of detecting the sound production period by the sound production period detecting unit 210. FIG. 10 is a flowchart illustrating an example of the methods of separating and synthesizing audio data by the audio data separating unit 220 and the audio data synthesizing unit 230. FIG. 11 is a reference diagram illustrating gains and phase adjustment amounts obtained in the example shown in FIG. 8.

An example where the imaging apparatus 1 tracks and images an imaging subject P which comes closer to Position 2, which is at the front side of a screen, from Position 1, which is at deep side of the screen, to acquire plural continuous image data as shown in FIG. 8 will be described below.

When a user inputs a turn-on instruction through the use of the power button 133, the imaging apparatus 1 is supplied with power. Then, when the release button 132 is pressed, the imaging unit 10 starts its imaging, converts an optical image formed on the image pickup device 102 into image data, generates plural image data as continuous frames, and outputs the generated image data to the sound production period detecting unit 210.

The sound production period detecting unit 210 performs a face recognizing process on the image data by the use of a face recognizing function to recognize the face of an imaging subject P. Then, pattern data representing the recognized face of the imaging subject P is prepared and the imaging subject P which is the same person based on the pattern data is tracked. The sound production period detecting unit 210 additionally detects image data of the mouth area in the face of the imaging subject P, compares the image data of the image region in which the mouth is located with the mouth-opened template and the mouth-closed template, and determines whether the mouth is opened or closed on the basis of the comparison result (step ST1).

Then, the sound production period detecting unit 210 detects a variation amount, which is an amount how the opened or closed state of the image data, which is obtained by the above-mentioned way, varies in time series, and detects a predetermined period as a sound production period when the opened or closed state varies continuously for the predetermined period. Here, a period t11 in which the imaging subject P is located in the vicinity of Position 1 and a period t12 in which the imaging subject P is located in the vicinity of Position 2 are detected as the sound production periods.

The sound production period detecting unit 210 outputs sound production period information representing the sound production periods t11 and t12 to the FFT unit 221. For example, the sound production period detecting unit 210 outputs synchronization information given to the image data corresponding to the sound production periods as the sound production period information representing the detected sound production periods t11 and t12.

When receiving the sound production period information, the FFT unit 221 specifies audio data corresponding to the sound production periods t11 and t12 out of the audio data acquired by the audio data acquitting unit 12 on the basis of the synchronization information which is the sound production period information, separates the acquired audio data into the audio data corresponding to the sound production periods t11 and t12 and the audio data corresponding to the other periods, and performs a Fourier transform on the audio data in the each periods. Accordingly, it is possible to acquire the sound production period frequency bands of the audio data corresponding to the sound production periods t11 and t12 and the out-of-sound production period frequency bands of the audio data corresponding to the periods other than the sound production periods.

The audio frequency detecting unit 222 compares the sound production period frequency bands of the audio data corresponding to the sound production periods t11 and t12 with the out-of-sound production period frequency bands of the audio data corresponding to the other periods on the basis of the result of the Fourier transform on the audio data acquired by the FFT unit 221, and detects the audio frequency band which is the frequency band of the imaging subject in the sound production periods t11 and t12 (step ST2).

The inverse FFT unit 223 extracts and separates the audio frequency band acquired by the audio frequency detecting unit 222 from the sound production period frequency bands in the sound production periods t11 and t12 acquired by the FFT unit 221, performs an inverse Fourier transform on the separated audio frequency band, and detects subject audio data. The inverse FFT unit 223 performs the inverse Fourier transform on the peripheral frequency band which is the remainder obtained by removing the audio frequency band from the sound production period frequency band and detects the peripheral audio data (step ST3).

The inverse FFT unit 223 outputs the peripheral audio data and the subject audio data acquired from the audio data in the sound production periods t11 and t12 to the audio data synthesizing unit 230.

On the other hand, as shown in FIG. 8, when the imaging subject coming closer to the front side of the screen from the deep side of the screen is imaged, the image data acquired by the imaging unit 10 is output to the sound production period detecting unit 210 as described in step ST1, and the face of the imaging subject P is recognized by the use of the face recognizing function. Accordingly, the imaging control unit 111 calculates the focal distance f from the focus to the imaging plane of the image pickup device 102 on the basis of the focus position acquired by the lens driving unit 104 while moving the AF lens 101b so as to be in focus with the face of the imaging subject P. The imaging control unit 111 outputs the calculated focal distance f to the displacement angle detecting unit 260.

When the face recognizing process is performed by the sound production period detecting unit 210 in step ST1, the position information of the face of the imaging subject P is detected by the sound production period detecting unit 210 and the detected position information is output to the displacement amount detecting unit 250. The displacement amount detecting unit 250 detects the displacement amount x representing the distance by which the image region corresponding to the face of the imaging subject P is separated in the lateral direction of the subject from the center axis passing through the center of the image pickup device 102 on the basis of the position information. That is, the distance between the image region corresponding to the face of the imaging subject P and the center of the screen in the screen of the image data captured by the imaging unit 10 is the displacement amount x.

The displacement angle detecting unit 260 detects the displacement angle θ formed by the line connecting the optical image P′ of the imaging subject P on the imaging plane of the image pickup device 102 to the focus and the center axis, on the basis of the displacement amount x acquired from the displacement amount detecting unit 250 and the focal distance f acquired from the imaging control unit 111.

When detecting the displacement angle θ, the displacement angle detecting unit 260 outputs the displacement angle θ to the multi-channel phase calculating unit 280.

The multi-channel phase calculating unit 280 calculates the phase adjustment amount Δt to be given to the audio data for each channel of the multi-speaker in the sound production period on the basis of the displacement angle θ detected by the displacement angle detecting unit 260.

That is, the multi-channel phase calculating unit 280 calculates the phase adjustment amount Δt_{R} to be given to the audio data of the right channels output to speakers FR (Front-Right) and RR (Rear-Right) disposed on the right side of the user through the use of Expression 4 and acquires +0.1 ms as the phase adjustment amount Δt_{R} at Position 1 and −0.2 ms as the phase adjustment amount Δt_{R} at Position 2.

Similarly, the multi-channel phase calculating unit 280 calculates the phase adjustment amount Δt_{L} to be given to the audio data of the right channels output to speakers FL (Front-Left) and RL (Rear-Left) disposed on the left side of the user through the use of Expression 5 and acquires −0.1 ms as the phase adjustment amount Δt_{L} at Position 1 and +0.2 ms as the phase adjustment amount Δt_{L} at Position 2.

The acquired values of the phase adjustment amounts Δt_{R} and Δt_{L} are shown in FIG. 11.

On the other hand, the imaging control unit 111 outputs the focus position acquired by the lens driving unit 104 to the distance measuring unit 240 during the above-mentioned focusing.

The distance measuring unit 240 calculates the subject distance d from the subject to the focus of the optical system 101 on the basis of the focus position input from the imaging control unit 111 and outputs the calculated subject distance to the multi-channel gain calculating unit 270.

The multi-channel gain calculating unit 270 calculates a gain (amplification factor) of the audio data for each channel of the multi-speaker on the basis of the subject distance d calculated by the distance measuring unit 240.

That is, the multi-channel gain calculating unit 270 calculates a gain Gf to be given to the audio data of the front channels output to the speakers FR (Front-Right) and FL (Front-left) disposed in the front of the user by the use of Expression 2, and acquires 1.2 as the gain Gf at Position 1 and 0.8 as the gain Gf at Position 2.

Similarly, the multi-channel gain calculating unit 270 calculates a gain Gr to be given to the audio data of the rear channels output to the speakers RR (Rear-Right) and RL (Rear-left) disposed in the back of the user by the use of Expression 3, and acquires 0.8 as the gain Gr at Position 1 and 1.5 as the gain Gr at Position 2.

The acquired gains Gf and Gr are shown in FIG. 11.

Referring to FIG. 10 again, when the gains acquired by the multi-channel gain calculating unit 270 and the phase adjustment amounts acquired by multi-channel phase calculating unit 280 are input to the audio data synthesizing unit 230, the gains and the phase adjustment amounts of the subject audio data are controlled for each of the channels FR, FL, RR, and RL of the audio data to be output to the multi-speaker (step ST4) and the subject audio data is synthesized with the peripheral audio data (step ST5). Accordingly, audio data in which the gains and phases of only the subject audio data are controlled is generated from each of the channels FR, FL, RR, and RL.

As described above, the audio data synthesizing apparatus according to this embodiment detects a section in which the opened or closed state of the mouth of the imaging subject continuously varies in the image data as an sound production period, performs the Fourier transform on the audio data corresponding to the sound production period and the audio data acquired in the time region other than the sound production period and around the sound production period which are out of the audio data acquired at the same time as the image data, and acquires the sound production period frequency band and the out-of-sound production period frequency band.

By comparing the sound production period frequency band with the out-of-sound production period frequency band, it is possible to detect a frequency band corresponding to a sound produced by the imaging subject at the sound production period frequency band.

Therefore, it is possible to control the gain and the phase of the frequency band of audio data corresponding to a sound produced from an imaging subject and to generate audio data which can reproduce a pseudo-acoustic effect.

The audio data synthesizing apparatus according to this embodiment includes the multi-channel gain calculating unit 270 in addition to the multi-channel phase calculating unit 280 and gives different gains for the each channels corresponding to the front and rear speakers depending on the subject distance d by giving a gain to the audio data to correct the audio data. Accordingly, it is possible to pseudo-reproduce the sense of distance between the photographer capturing the image and the subject to the user who is listening to the sound output from the speakers by using the sound pressure level difference.

In a surround system speaker employing a technique which reproduces the shift of the audio data of front and rear speakers with a lag, such as a technique of a pseudo surround effect in advance, a satisfactory acoustic effect may not be achieved by only the phase adjustment amount Δt acquired by the multi-channel phase calculating unit 280. When a variation in head-related transfer function depending on the subject distance d is small, the correction of the audio data based on the phase adjustment amount Δt acquired by the multi-channel phase calculating unit 280 may not be appropriate. Accordingly, as described above, by including the multi-channel gain calculating unit 270 in addition to the multi-channel phase calculating unit 280, it is possible to solve the problem which cannot be solved by only the above-mentioned multi-channel phase calculating unit 280.

The audio data synthesizing apparatus according to this embodiment has only to have a configuration including at least one audio data acquiring unit 12 and separating the audio data into two or more channels. For example, in the case of a stereophonically-input sound (two channels) in which two audio data acquiring units 12 are disposed on the right and left sides, audio data corresponding to 4 channels or 5.1 channels may be generated on the basis of the audio data acquired from the audio data acquiring units 12.

For example, when the audio data acquiring unit 12 include plural microphones, the FFT unit 221 performs a Fourier transform on the audio data in the sound production period and the audio data in the period other than the sound production period for the audio data for each microphone and acquires the sound production period frequency band and the out-of-sound production period frequency band from the audio data for each microphone.

The audio frequency detecting unit 222 detects the audio frequency band for each microphone, and the inverse FFT unit 223 performs an inverse Fourier transform on the peripheral frequency band and the audio frequency band for each microphone to generate peripheral audio data and subject audio data.

The audio data synthesizing unit 230 synthesizes the subject audio data of each microphone of which the gains and phases are controlled on the basis of the peripheral audio data of each microphone and the gain and the phase adjustment amount set for each channel corresponded to the microphone, for each channel of the audio data to be output to the multi-speaker.

In a recent imaging apparatus, there are a demand for a decrease in size and a demand for an increase in size of a display unit mounted on the imaging apparatus so as to allow a user to simply carry it and realize a function of capturing various image data such as moving images or still images.

Here, when two microphones are mounted on an imaging apparatus in consideration of the directivity of sound, there is a problem in that an effective use of the space in the imaging apparatus cannot be achieved to disable a decrease in size of the imaging apparatus or there is a problem in that the spacing between two microphones is not enough and thus the direction or position of a sound source is not satisfactorily detected, thereby not achieving a satisfactory acoustic effect. However, when a single microphone is used as in the imaging apparatus according to this embodiment, it is possible to pseudo-reproduce a sense of distance between the photographer capturing the image and the subject during the imaging using a sound pressure level difference, whereby it is possible to reproduce a realistic sound while effectively using the space in the imaging apparatus.

### BRIEF DESCRIPTION OF THE REFERENCE SYMBOLS

1: IMAGING APPARATUS
10: IMAGING UNIT
11: CPU
12: AUDIO DATA ACQUIRING UNIT
13: OPERATION UNIT
14: IMAGE PROCESSING UNIT
15: DISPLAY UNIT
16: STORAGE UNIT
17: BUFFER MEMORY UNIT
18: COMMUNICATION UNIT
19: BUS
20: STORAGE MEDIUM
101: OPTICAL SYSTEM
102: IMAGE PICKUP DEVICE
103: A/D CONVERTER
104: LENS DRIVING UNIT
105: PHOTOMETRIC SENSOR
111: IMAGING CONTROL UNIT
210: SOUND PRODUCTION PERIOD DETECTING UNIT
220: AUDIO DATA SEPARATING UNIT
221: FFT UNIT
222: AUDIO FREQUENCY DETECTING UNIT
223: INVERSE FFT UNIT
230: AUDIO DATA SYNTHESIZING UNIT
240: DISTANCE MEASURING UNIT
250: DISPLACEMENT AMOUNT DETECTING UNIT
260: DISPLACEMENT ANGLE DETECTING UNIT
270: MULTI-CHANNEL GAIN CALCULATING UNIT
280: MULTI-CHANNEL PHASE CALCULATING UNIT

1. An audio data synthesizing apparatus comprising:
an imaging unit that captures an image of a subject through an use of an optical system and outputs image data;
an audio data acquiring unit that acquires audio data;
an audio data separating unit that separates first audio data produced by the subject and second audio data other than the first audio data from the audio data; and
an audio data synthesizing unit that synthesizes the first audio data and the second audio data of which gains and phases are controlled for each channel of the audio data to be output to a multi-speaker on the basis of a gain and a phase adjustment amount set for each channel.

2. The audio data synthesizing apparatus according to claim 1, further comprising:
an imaging control unit that outputs a control signal for shifting the optical system to a position where the image of the subject is in focus and acquires position information representing a positional relationship between the optical system and the subject; and
a control factor determining unit that calculates the gain and the phase adjustment amount on the basis of the position information.

3. The audio data synthesizing apparatus according to claim 1, wherein the control factor determining unit further comprises:
a subject distance measuring unit that measures a subject distance to the subject on the basis of the position information;
a displacement amount detecting unit that detects a displacement amount from a center in an imaging plane of the imaging unit;
a displacement angle detecting unit that acquires a displacement angle formed by an axis passing through the focus and being perpendicular to the imaging plane and a straight line connecting the focus to the image of the subject on the imaging plane on the basis of the displacement amount and a focal distance in the imaging unit;
a multi-channel phase calculating unit that acquires the phase adjustment amount of the audio data for each channel on the basis of the displacement angle; and
a multi-channel gain calculating unit that calculates the gain of the audio data for each channel on the basis of the subject distance.

4. The audio data synthesizing apparatus according to claim 3, wherein the multi-channel phase calculating unit calculates the phase adjustment amount, which is controlled for each channel, on the basis of a relational expression between the displacement angle which is an incident angle of a sound and a time difference by which the sound is input to both ears.

5. The audio data synthesizing apparatus according to claim 3, the multi-channel gain calculating unit calculates a gain for each channel on the basis of the subject distance and a sound pressure level difference between front and rear channels of the audio data synthesizing apparatus.

6. The audio data synthesizing apparatus according to claim 1, wherein the audio data separating unit comprises:
an FFT unit that performs a Fourier transform on the audio data in an sound production period in which a sound is produced from the subject and the audio data in a period other than the sound production period;
an audio frequency detecting unit that compares a frequency band in the sound production period with a frequency band in the period other than the sound production period, and detects a first frequency band which is a frequency band of the sound of the subject in the sound production period; and
an inverse FFT unit that extracts the first frequency band from the frequency band in the sound production period, performs an inverse Fourier transform on the first frequency band and on a second frequency band which is other than the first frequency band, and generates the first audio data and the second audio data.

7. The audio data synthesizing apparatus according to claim 1, further comprising an sound production period detecting unit that detects the sound production period in which the sound is produced from the subject,
wherein the sound production period detecting unit recognizes a face of the subject through the use of an image recognizing process on the image data, detects an area of a mouth in the recognized face, and detects a period in which a shape of the mouth is changing as the sound production period.

8. The audio data synthesizing apparatus according to claim 7, wherein the sound production period detecting unit detects a position of the mouth in the recognized face by comparing the recognized face with a predetermined face template.

9. The audio data synthesizing apparatus according to claim 8, wherein the sound production period detecting unit detects the area of the mouth in the face template, comprises a mouth-opened template in which the mouth is opened and a mouth-closed template in which the mouth is closed, and detects an opened or closed state of the mouth of the subject by comparing the image of the area of the mouth with the mouth-opened template and the mouth-closed template.

10. The audio data synthesizing apparatus according to claim 3, wherein the audio frequency detecting unit generates a band-pass filter passing the first frequency band and a band-elimination filter passing the second frequency band, and
wherein the inverse FFT unit extracts the first frequency band from the frequency band by the use of the band-pass filter and extracts the second frequency band from the frequency band by the use of the band-elimination filter.

11. The audio data synthesizing apparatus according to claim 3, wherein the audio frequency detecting unit compares the frequency band in the sound production period with the frequency band in the period other than the sound production period in a frequency range of an orientable zone in which a human being can recognize a direction of a sound.

12. The audio data synthesizing apparatus according to claim 3, wherein the audio acquiring unit comprises a plurality of microphones,
wherein the FFT unit performs the Fourier transform on the audio data in the sound production period and the audio data in the period other than the sound production period for the audio data of each microphone,
wherein the audio frequency detecting unit detects the first frequency band for each microphone,
wherein the inverse FFT unit performs the inverse Fourier transform on the first frequency band and the second frequency band respectively for each microphone and generates the first audio data and the second audio data, and
wherein the audio data synthesizing unit synthesizes the second audio data for each microphone with the first audio data for each microphone of which the gain and the phase are controlled on the basis of the gain and the phase adjustment amount set for each channel corresponding to the microphone, for each channel of the audio data which is output to the multi-speaker.
